(19) United States
(12) Patent Application Publication
(10) Pub. No.: US 2006/0038678 A1
(43) Pub. Date: Feb. 23, 2006

(54) Security system and method

(76) Inventor: Shahar Avneri, Herzlia (IL)

Correspondence Address: SHAHAR AVNERI, 32 A NORDAV STREET, HERZLIA, 46594, IL

(21) Appl. No.: 11/008,105

(22) Filed: Dec. 10, 2004

(30) Foreign Application Priority Data
Jun. 10, 2002 (IL) 150123
Jun. 9, 2003 (WO) PCT/IL03/00484

(51) Int. Cl. G08B 13/00; B61B 3/00

(52) U.S. Cl. 340/541; 104/89

(57) ABSTRACT

A patrol system comprising a carriage moving along guiding means. The carriage includes propulsion means, sensors for acquiring data from outside the carriage and control means. An automatic safety method comprising A. storing a digital map of safety zones in a computer; B. keeping track in real time of the carriage location and the area pointed at by the weapon; C. when a weapon activation command is issued, checking whether the intended attack will be pointed towards one of the safety zones; D. if the answer in step C is negative, then activating the weapon; if the answer is positive, then shooting will not be allowed.

### TECHNICAL FIELD

The present invention claims priority from patent application 150123 filed in Israel on 10 Jun. 2002 and patent application PCT/IL03/00484 filed with RO/Israel on 9 Jun. 2003, wherein the latter application (PCT) claims priority from the former (Israel). This invention concerns security systems. The invention relates in particular to such systems comprising a plurality of carriages on rails for unmanned patrols along fences or borders.

### BACKGROUND ART

At present, despite the investments being made in manpower, equipment and other means for the protection of long borders or an area's perimeter, only a limited measure of success has been achieved. As the borders are exposed to many penetration and/or attack attempts, a significant part of these attempts may succeed, with disastrous results.

It may be impossible, or very expensive, to allocate manpower for protecting all the border line, all the time. Moreover, long range surveillance means such as radar or airborne reconnaissance may be limited by terrain obstructions or weather conditions. Thus, at night, in bad weather, in hilly terrain, it may be difficult to protect border areas.

The border protection task may be further divided to include a fast detection capability and a fast response capability. Fast detection refers to a capability to detect in real time any attempts of crossing the border or approaching a forbidden area near a fence, or attempts of tampering with the border fence.

Fast response refers to a capability to respond and/or deter would-be intruders or physically counterattack teams engaged in hostile activities, such as tampering with existing security means.

At present, much of the border surveillance and security is performed by manned patrols. A problem with this practice is that the border patrol forces themselves are convenient targets for the enemy. The enemy can, with relative ease, learn the routine of the guards and mount attacks against the guarding soldiers.

A further problem is that, by learning the routine of the guards, potential intruders may determine the opportune time for infiltrating the protected area, unhindered.

Moreover, the effectiveness of the patrol forces is limited by fatigue, adverse weather, low visibility and impassable terrain conditions.

Whereas armies and civilian security forces now use modern technology, the activities of guards along borders or perimeters are still being carried out in the same old fashion as in the past.

Where weapons in a patrol unit are remotely controlled and activated, there is the danger of firing at civilians. The operator at a remote center may activate the weapon by mistake, towards a forbidden location. The problem is further aggravated for a system intended to protect a long border, which may include hospitals, villages, settlements and other locations at which firing is not permitted.

It is an objective of the present invention to overcome the abovedetailed problems in security systems.

### DISCLOSURE OF INVENTION

It is an object of the present invention to provide a security system and method with carriage means on rails for border surveillance.

This object is achieved by a patrol system as disclosed in claim 1.

The system may perform unmanned patrols along fences, perimeters or borders. The system includes one or more mobile patrol devices, each mounted in a carriage moving along a rail installed at the border area. Each carriage is equipped with propulsion means for moving it along the rail as desired.

Each patrol device further includes sensor means, such as imaging means, infrared sensors, audio sensors, radar, etc. The patrol devices may also include remotely activated means for active intervention, as desired. The patrol devices may also include remotely activated weapons.

The patrol devices include communication means for transmitting reports to a control center and for receiving commands regarding the movement of the device, sensors control and weapons activation.

Thus, the new patrol system can provide both a fast detection capability and a fast response capability. These benefits are achieved in an unmanned system, without unnecessarily exposing patrols to unexpected attacks. The system can operate day and night, in adverse weather, to quickly reach any remote location.

The rail can be installed in such a way as to adapt to the terrain characteristics and tactical requirements, for example to allow the surveillance of canyons and valleys. This structure enables the patrol devices to climb up hills and scan areas that may be inaccessible to motorized forces or foot soldiers or guards.

In case a manned force's intervention is deemed necessary, the above patrol system can be very useful, for example in guiding the forces to the area of interest, in providing real time intelligence, area illumination and/or support fire as required.

The benefits of the patrol system include, among others:
Quick response time.
Savings in manpower. A cost effective solution.
Reduced exposure of guard forces to enemy attacks.
Reduced vulnerability with respect to fixed installations such as fixed cameras or other fixed surveillance means.
Possibility of control and decision-making by higher authorities.
Cease-fire zones can be defined in advance and may be automatically enforced
Capability to carry out frequent patrols, at irregular time intervals and with varying parameters such as speed and acceleration, even in adverse weather. Such unconventional patrols may confuse the enemy and disturb their plans.
A fast response capability, using intervention devices or weapons on board the patrol device, for example.
A capability for carrying advanced equipment, such as a thermal imaging device, to places along the perimeter, where it would normally not be available, for various reasons such as the equipment weight, price and/or power requirements.

In one embodiment of the invention, the rails are installed overhead, with the patrol carriages moving at a certain height above the terrain. In another embodiment, the rails are installed on the ground, and the patrol devices move close to ground level. The rails and carriages may be hidden by the terrain.

In the latter case, the carriages may further include means for elevating the carriage above ground level to an operational height, when so required. Alternately, only the sensor or weapon means are elevated to a certain height when it is desired to activate these means.

In the case of the overhead rail, the sensor or weapon means may also be elevated or lowered down, as the operator may desire.

The present invention may have various uses, including for example perimeter patrols at prisons or industrial installations. The weapons are optional, and may be disposed with in civilian applications.

Further objects, advantages and other features of the present invention will become obvious to those skilled in the art upon reading the disclosure set forth hereinafter.

### BRIEF DESCRIPTION OF DRAWINGS

The invention will now be described by way of example and with reference to the accompanying drawings in which:

FIG. 1 illustrates a patrol and security system

FIG. 2 details the structure of a patrol carriage on rail

FIG. 3 details a cross-sectional view of the patrol carriage on rail

FIG. 4 is a block diagram of the patrol carriage on rail.

FIG. 5 details a cross-sectional view of another embodiment of the patrol carriage on rail.

FIG. 6 details a cross-sectional view of yet another embodiment of the patrol carriage on rail.

FIGS. 7 and 8 detail means for clearing the rail of possible obstructions.

FIG. 9 is a block diagram of an automatic, electronic safety means for the firearms activation.

FIGS. 10 and 11 detail the method of operation of the electronic safety means for firearms activation.

### MODES FOR CARRYING OUT THE INVENTION

A preferred embodiment of the present invention will now be described by way of example and with reference to the accompanying drawings.

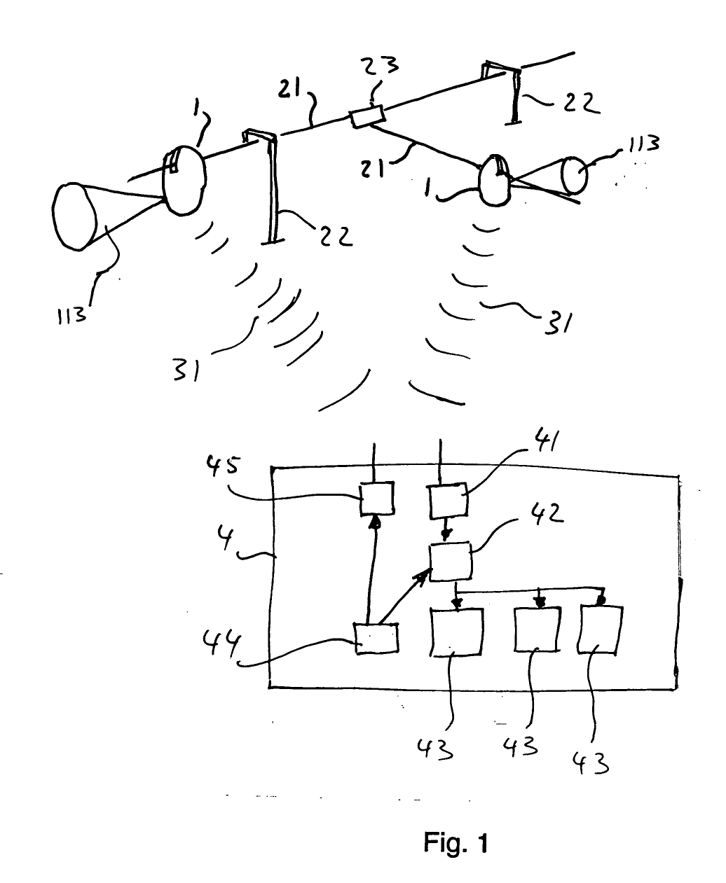

FIG. 1 illustrates a patrol and security system including patrol carriages 1 sliding on rails 21, supported by pylons 22. A plurality of rails 21 may be installed, with rails intersection means 23 therebetween.

Such a plurality of rails 21 and intersections 23 may facilitate the carriage movement along any of several paths, to cover a wider area, and to allow two units, which are traveling on the same rail in opposite directions, to pass over one another.

The actual carriage movement may be controlled by a control center, as detailed elsewhere in the present application. For example, the patrol carriages may alternately move along different rails, with several rails running in parallel at different heights, for irregular patrols and to confuse the enemy.

The carriages may include stabilization wheels, as detailed below.

Imaging sensors in carriages 1 have an imaging field of view 113 as illustrated. As the carriage 1 moves along the rail 21, an image of the scanned area is transmitted to a surveillance and control center 4.

Either a narrow or a wide field of view 113 can be implemented, as desired. Telescopic or zooming means may be used for acquiring image details.

Other sensors may include panoramic cameras, possibly including several imaging sensors, concurrently activated for a wider field of view.

The sensors may include thermal imaging means, a video camera, a camera with panoramic view, radar or other surveillance means.

The image information may be transmitted by radio (RF) waves 31, for example, to the center 4. The surveillance and control center 4 is equipped with a suitable RF receiver 41 and with computer and image presentation means 42.

Other communication means may be used in lieu of radio waves. For example, ultrasonic waves may be transmitted through the rail 21; cables or waveguides along the rail 21 may be also used to that purpose. Satellite communications may also be used. Furthermore, relay stations may be used to increase the range of communication links, or where terrain obstructions require that. The information may be encrypted, to help prevent an enemy's attempts at disrupting communications and to preserve the carriage's safety.

A plurality of display means 43 can be used to concurrently display several images, from several patrol carriages 1. Alternately, a separate, dedicated link and display 43 may be used with each carriage 1, to display images or other sensor data related to that carriage. A plurality of control centers may be used, each controlling one carriage or several carriages.

Center 4 can further include recorder means for recording data received from the sensors in the patrol carriages 1, as well as activities performed.

Input means 44 can be used for receiving operator's commands to control carriages, displays and any other component of the system. The input means 44 may include graphic input means and/or alphanumeric input means for example a joystick, digitizer, keyboard, etc. Commands to the carriages can be sent through a transmitter 45.

The center 4 may include computer means with programs for automatically directing a carriage to a desired location when an alarm is received. The computer can manage the movement and location of all the carriages in the system, in real time, according to preprogrammed criteria.

Each carriage can thus transmit images as it moves along the rail, or while standing still at a desired location, or while standing at that location and scanning the area using its sensors. Such activities may be responsive to operator's commands received from the center 4.

The carriage may further include a loudspeaker 112, for addressing a suspect nearby, or for other uses.

Thus, a bi-directional communication link is achieved:
1. From the carriages 1 to center 4, to transmit images or video information, as well as other sensors data as desired;
2. From center 4 to each carriage 1, to transmit control signals, weapons activation, voice messages, etc.

In another implementation of the invention, the carriage moves according to a preprogrammed plan in a local controller. The plan may include a plurality of locations, velocities and accelerations along a desired path. Sensor pointing can also be preprogrammed, to scrutinize specific points of interest along the patrol path. In this case, the control link from the center can be disposed with. A lower cost system may be achieved, and with a more robust operation—no continuous control from a center is required.

In yet another implementation of the invention, the system includes means for recording the sensor data locally in recorder means in the carriage, rather than transmitting it to a center in real time. The data can be downloaded when the carriage reaches a support center or a specific location with suitable facilities. Such a structure may not require a transmitter, thus a lower cost device may be achieved, that is also more secure.

In case the communication link with the center is broken, the carriage may include control means for automatically directing it to a maintenance depot. The relevant parameters may be preprogrammed in the unit.

Furthermore, the carriages may include means for linking two carriages together, to allow one carriage to drag a damaged one to a maintenance depot, for example.

The system thus provides for easy and fast transfer of remotely controlled patrol means 1, to be used for surveillance and control in remote locations. The patrol means can provide a fast response to alarm calls or can be used for routine patrols. The rail 21 may be installed along a fence, a border or the perimeter of a secured area.

The motorized and unmanned patrol means 1 are equipped with image sensing equipment and transmitter means for transmitting the images to a remote control center 4.

One or more patrol units 1 can be installed on the rail 21, each patrol unit including propulsion means for moving along the rail, sensor means for surveillance and weapon means for providing an immediate intervention facility.

Communication means in the patrol means enables transmission of image information and sound, and allows for remote control of the propulsion means (engine), the sensors (cameras) and weapon systems, in real time.

The rail itself can be used as a pathway for transferring electrical power and/or information and control to/from the patrol unit.

The optics and weapon systems can be installed on a revolving turret, that can be remotely pointed at a target by the operator. A powerful engine having a high output relative to the weight of the unit, can provide a high acceleration for the unit, to achieve a high speed in a short time.

The activity of the patrol units 1 can be controlled by an operator or a computer at the control center 4. The course of each unit can be programmed in the main computer, so as to achieve a fast response time: when intervention is required at a specific location, there will be a patrol unit nearby that can be brought at short notice to that location.

The patrol program, taking into account the whole length of the track and the units thereon, can be so devised as to ensure that, at any moment, one of the patrol units can reach any point on the rail, within a period of time which will not exceed the maximal response time.

The maximal response time can be a system constraint, forming a basis for the system design: the number of patrol units required for a given track length and for a given speed and acceleration of each unit.

Thus, in case of a warning being issued at the electronic fence, an available patrol unit which is close to the source of that warning, can be sent automatically by the computer at the control center. An image of the suspect site or of the incident is sent to the control center, and a human operator decides how to respond.

Response Method

When he/she recognizes a suspect activity, the operator has several alternative ways to handle it:

1. Reporting the incident to a higher authority, either at the same control center 4 or to a remote location. The sensors information can be passed along with the report.

2. Determining a suspect object's exact location using a laser range finder installed in the patrol unit. The range finder's exact bearings are known, as well as the unit's exact location, thus enabling to compute the object's precise location in space at the computer in center 4.

3. Listening in to an incident in real time, using for example a directional microphone installed in the patrol unit 1.

4. Directing illumination means, such as a projector, towards the suspect object. A spot light or a flood light source may be used.

5. Addressing a suspect using a loudspeaker, with a message recorded in advance, such as “Stop”, “Identify yourself”, etc. Alternately, an audio link can be formed between center and remote patrol unit, to implement a real time dialog with a suspect. Thus, the system can output either recorder or live speech.

6. Raising illumination bombs.

7. Activating firearms

8. Directing laser-guided weapons at the enemy forces, using laser designator means in the carriage 1.

9. Supporting assault troops being sent to the location, and transmitting images of the area, the enemy location and other known information, to the commander of the intervention forces.

Further Advantages of the System:

Performing surveillance from high places or commanding heights.
Protecting settlements close to the fence, by installing the rail 21 such as to include these settlements in the patrol paths.
Programmed firing zones (sector borders), to prevent firing of live ammunition towards specific areas (civilians, friendly forces, etc.)
Height advantage: it is possible to position the patrol unit at a desired height, to ensure a better angle and an unobstructed field of view for observation and weapons activation.
Possibility of transmitting images to manned patrol vehicles.
The system is less vulnerable than static cameras installed at border locations.
Allows for the use of relatively expensive imaging devices, such as thermal and telescopic devices.
Providing protection and early warning to forces moving along the border.
Redundancy: Failure of one of the cameras or patrol units, will not create blind spots or a failure of the patrol system.

In another embodiment, the rails 21 are installed on the ground, and the patrol devices 1 move close to ground level. The rails and carriages may be hidden by the terrain.

The computer 42 may include pattern recognition means, for automatically detecting movements or “hot” targets in the thermal imagery.

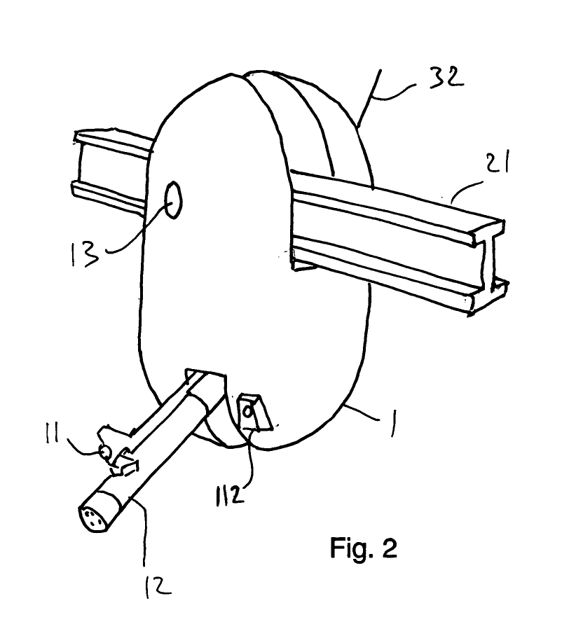

FIG. 2 details the structure of a patrol carriage 1 on rail 21. The image acquisition means 11 may include optics, a video camera, infrared (IR) sensors, radar sensors, sonic sensors, ultrasonic sensors, etc.

A gun 12 or other attack weapons means, such as a submachine gun, may be installed in the carriage 1, with means for weapons activation by electronic means. Some weapons already have an electrical activation input, for example the Vulcan minigun. Other weapons, devised for manual use, can be adapted for use in the patrol units by the addition of activation means. The activation means may include, for example, actuator means connected to the weapon's trigger, a solenoid or an electric motor with means for translating its rotational motion to a linear movement.

A flare launcher opening 13, can be used for releasing flares or illumination bombs.

An antenna 32 is used for transmitting/receiving radio transmissions. Thus, as carriage 1 moves along rail 21 or stands still at a desired locations, all the abovedetailed means are active and linked to a control center to provide surveillance or to allow a fast intervention, as the need be.

The rail 21 may further include means for indicating the location of the carriage 1 thereon, for example optical or magnetic markings. In adverse weather, the carriage may slip along the rail, and its precise location may be of importance for the patrol mission. Alternately, location sensing means in the carriage, such as a GPS receiver, can be used.

Although in FIG. 2 the patrol carriage 1 moves on a rail 21, other embodiments are possible as well. For example, one or more cables may be used in lieu of the rail 21. In a preferred embodiment, three parallel cables are used, preferably not in the same plane, to provide a lower cost alternative and also to achieve a measure of carriage stabilization. Other stabilization means may be used, using a gyroscope for example.

Rather than being remotely controlled, the carriage 1 may be manned, including a suitable turret for carrying a soldier or patrolman who is also protected inside the carriage. That person may also activate the weapons as desired.

The means for attaching the carriage to rail 21 may include rotary joints or similar means, to keep the carriage horizontal (or at the same orientation) despite a possible inclination of the rail 21. Such means may help keep the sensors and weapons aligned in a desired direction. In one embodiment, a level may be used for keeping the carriage level. In another embodiment, the weapon and sensor systems are parallel to the rail, and electronic/computer means are used to level them for ballistic corrections and image leveling.

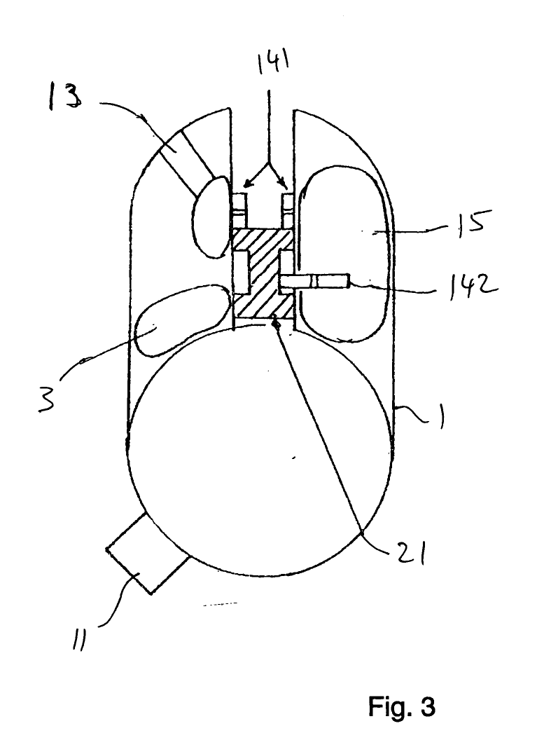

FIG. 3 details a cross-sectional view of the patrol carriage 1 on rail 21. The wheels 141 are used for supporting the weight of the carriage 1 and for securing it to rail 21, as well as for improving the carriage stability.

The drive wheel 142 is used for carriage propulsion along the rail, for securing the carriage 1 to rail 21 and for improved stability.

The propulsion means 15, such as a motor or engine with a gear box, or an electric motor or other means, are mechanically coupled to the drive wheel 142 for moving the carriage 1 along the rail 21. Electrical motors are silent and can move the carriage without noise to a desired location, to surprise a would-be intruder.

However, electrical power sources have a lower power/weight ratio than that of combustion fuel used in conventional fuel engines. For fast patrols of long distance borders, combustion engines may provide a more appropriate propulsion means.

A flare launcher 13 or illumination bomb launcher or grenade launcher or similar means has an opening for launching the above means as desired, when the device is being electrically activated from the control center.

The image acquisition means 11 may include various means as detailed above.

The communication means 3 allows for communications between the above detailed means in the carriage 1 and a remote center.

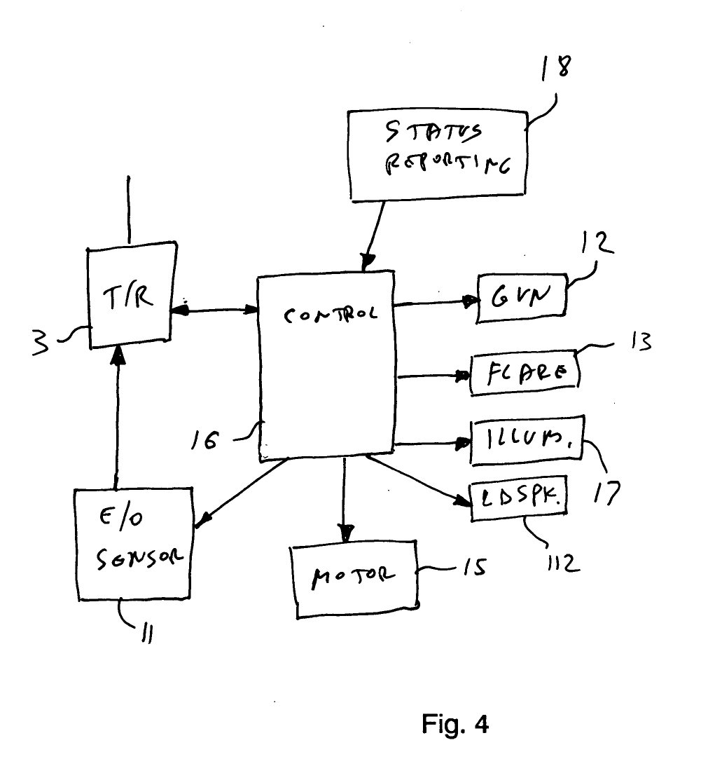

FIG. 4 is a block diagram of the patrol carriage. A controller or computer 16 controls the various activities of the carriage, according to local programs and/or commands from a remote center. For example, the computer 16 is connected to the propulsion means 15, to control the movement of the carriage along the rail.

A flare launcher 13, with means for its activation by an electrical signal, can also be fired by controller 16 under remote control. The image acquisition means 11 may include various means as detailed above. Its output is transferred to the communication means 3, for transmission to a remote center. The means 11 may receive commands through means 3, for example commands for pointing it in a desired direction, focus control, etc.

The weapons means 12, such as a machine gun, can also be activated by the controller 16 under local or remote guidance.

The illumination means 17 are also controlled by controller 16. The status reporting means 18 can sense various conditions in the carriage and transfer electrical signals indicative thereof to controller 16, for transfer to a remote center.

A loudspeaker 112 can be used, for addressing a suspect for example, using either messages locally stored in controller 16 or voice messages received from a remote location.

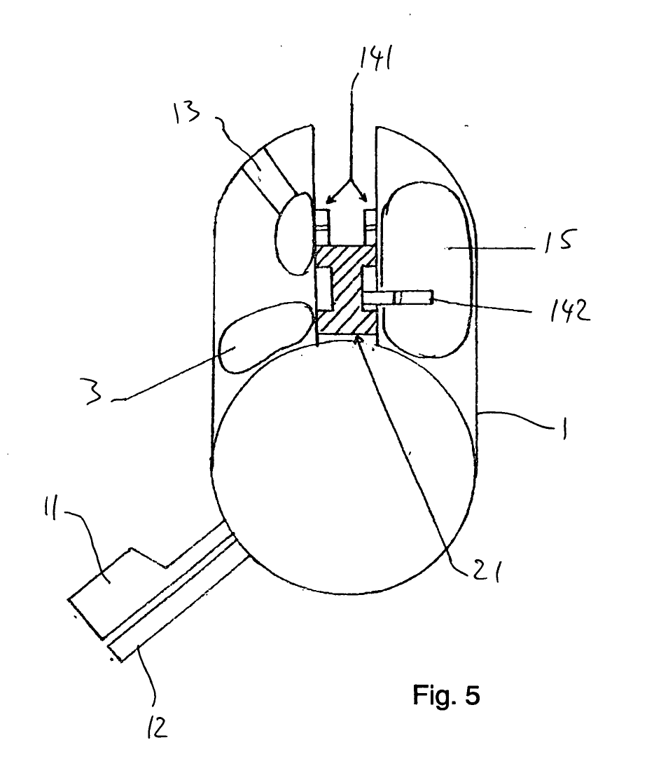

FIG. 5 details a cross-sectional view of another embodiment of the patrol carriage 1. It has wheels 141 for supporting the weight of the carriage 1 and for securing it to rail 21 and for improved carriage stability. The drive wheel 142 is used for carriage propulsion along the rail, for securing the carriage 1 to rail 21 and for improved stability.

The propulsion means 15 is mechanically coupled to the drive wheel 142 for moving the carriage 1 along the rail 21.

The device further includes a flare launcher 13. The image acquisition means 11 may include optics or other means.

The communication means 3 may include radio transmitter/receiver means.

The system also includes weapons means 12, such as a machine gun. A common turret may be used to point both the weapon means 12 and the imaging means 11 in the same direction, for surveillance or active countermeasures. The system may be calibrated for the weapon and imaging means to point in the same direction, for effective weapon aiming.

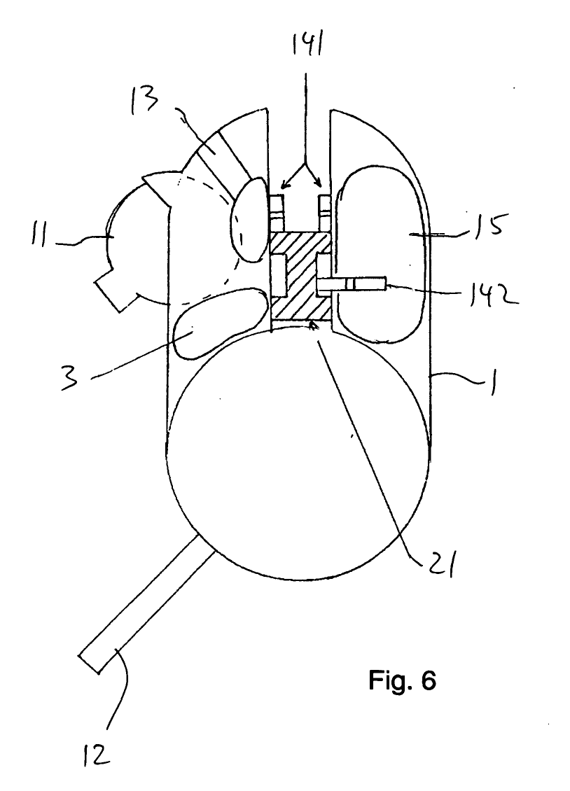

FIG. 6 details a cross-sectional view of yet another embodiment of the patrol carriage 1 on rail 21. In this embodiment, the imaging means 11 is located at the upper part of the carriage 1, and is thus separated from the weapon means 12. The system may be calibrated for the weapon and imaging means to point in the same direction, for effective weapon aiming.

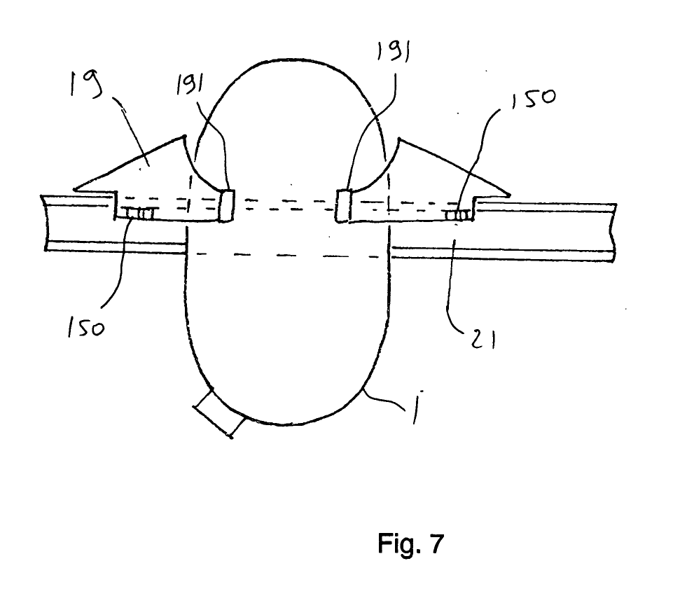

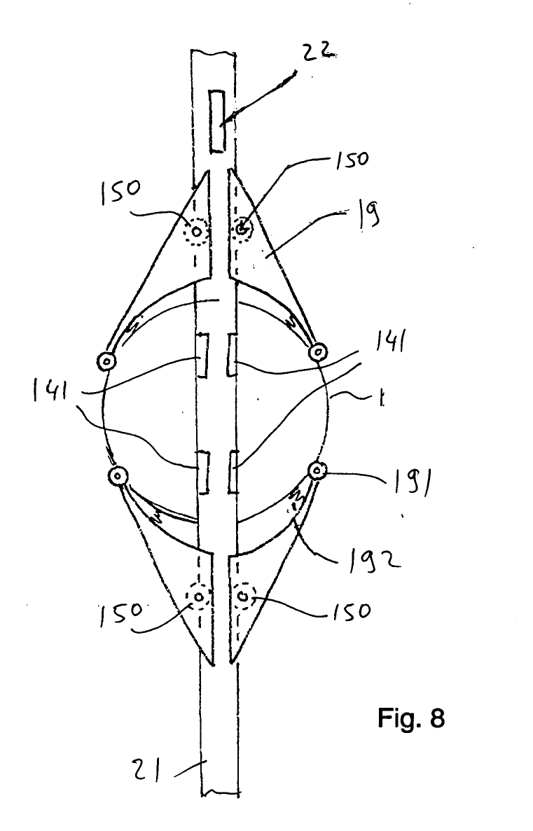

FIGS. 7 and 8 detail means for clearing the rail 21 of possible obstructions thereon. Each carriage may include collision prevention means, to prevent it from colliding with another carriage or an obstruction on the rail.

In one embodiment, the clearing means may include a shield 19 pointed along the rail 21, and attached to the patrol unit 1 by hinges 191 and spring 192 (preferably using a pulling spring). Wheels 150 allow the shield 19 to follow the curves in the rail path. The structure allows the unit 1 to pass along the pylons 22 supporting the rail 21, while the shield 19 removes obstructions off the rail 21.

The means for holding the carriage to rail 21 may further include means for releasing the carriage from the rail if necessary. Such a necessity may arise during units maintenance, when the rail is damaged or to prevent the carriage from being captured by the enemy, for example.

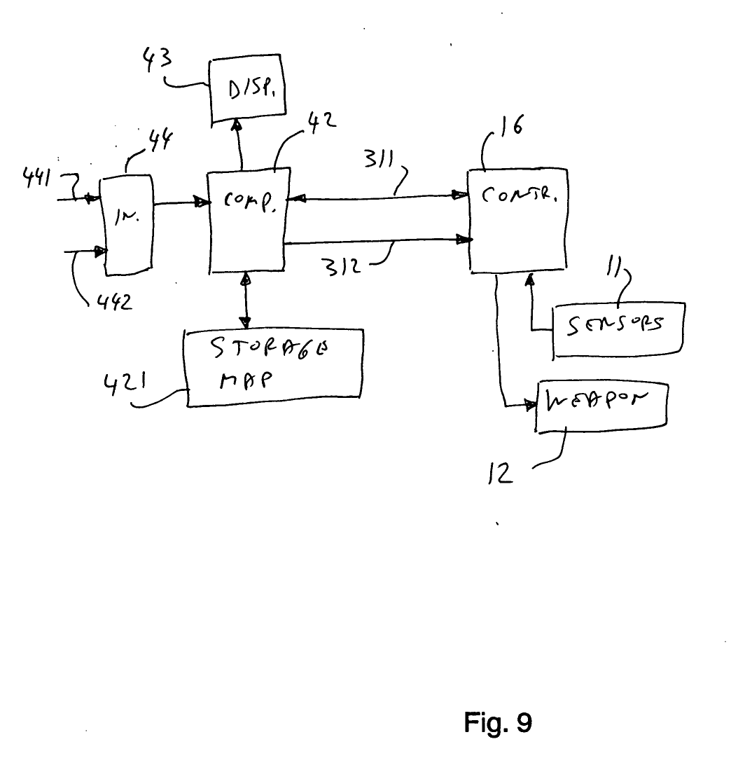

FIG. 9 is a block diagram of an automatic, electronic safety means for the firearms activation.

At the surveillance and control center, the computer and image presentation means 42 further includes map storage means 421 including protected areas, which are not to be fired at, as well as height information, including for example terrain topography and building's height. As a carriage's image acquisition means 11 are pointed at a possible target, the image thus acquired is transmitted to the center through the sensors and control channel 311, to be displayed on display means 43 through the computer 42.

The carriage controller 16 further transmits operational information such as that unit's location, the gun bearings, range to target, etc. The information may be displayed on display 43 and/or may be processed in the computer 42. A target's position may be computed accordingly.

An operator's commands 441 are received in computer 42 through the input means 44, and are used to control the carriage operation, including weapon's firing commands.

Firing Zones Definition Method

The firing zones can be divided into three basic types:

1. Protected zones: These are areas 511, 512, 513, 521, 522, 523 at which firing is not permitted (firing is disabled), and may include for example villages, hospitals, friendly forces, etc. These zones may be stored in a digital map in a computer. Data protection means may be used, to only allow changes in the digital map to be made by authorized users.

2. Safety zones: These are areas 51, 52 at which firing is disabled as a safety precaution, and may be each an enhancement of a protected zone, to include additional belts adjacent to the protected zone.

3. Fire permitted zones: These are areas at which firing is permitted, and are defined to exclude the abovedetailed protected zones and/or safety zones.

Automatic Safety Method

The automatic safety program can operate in one of two modes:

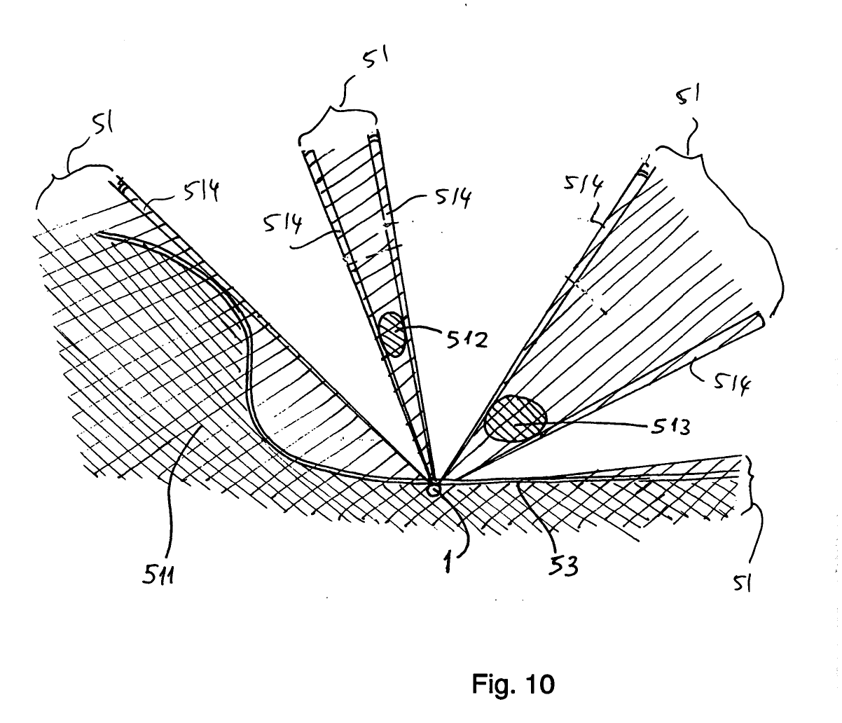

1. Angle mode, as illustrated in FIG. 10. For each protected zone, there is a protected angle. The protected angle will include all the angular sector defined by the extremities of the protected zone 512, 513, as seen at the patrol unit (the resulting angle of view). This angle can be enhanced, in both directions (left and right) by a predefined amount 514, to define the safety angle 51.

Thus, only angular information is used, with no regard to range. A simpler digital map is necessary. In one preferred embodiment, the safety zone is not stored in a computer's memory—the memory only stores the protected zones. When a firing command is given, then the computer will check whether the line of fire lies within the safety zone. If the answer is positive, then firing will not be permitted.

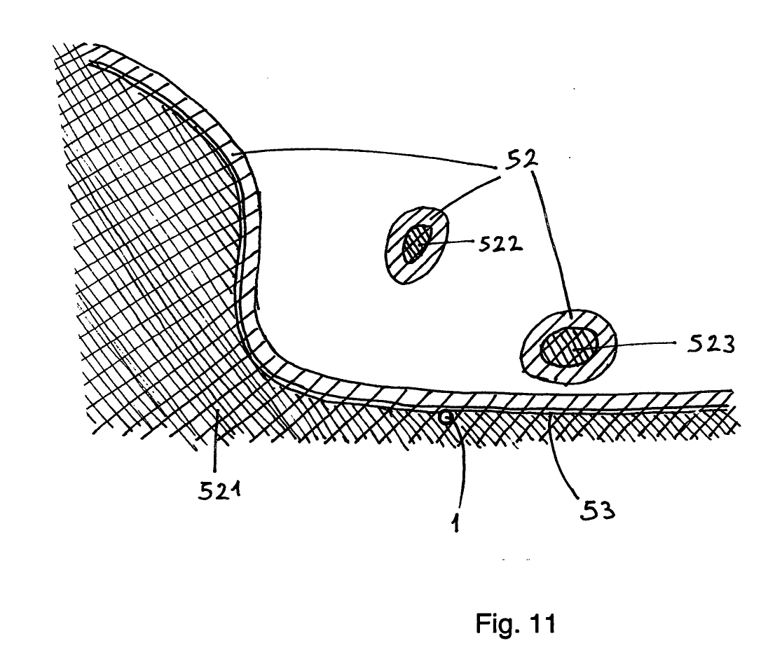

2. Distance mode, as illustrated in FIG. 11. For each protected zone, a safety zone can be defined as an enhancement of the protected zone, to include an additional border around it. The safety zone is defined both in angle and range. Firing is permitted outside an area defined by the safety area 52.

A tri-dimensional computer map may be used to store the safety zones. Height of buildings in the area, possible obstructions and other terrain features may be included in the digital map. Thus, the weapon automatic safety means can take these factors into account. A finer distinction between safety zones and fire permitted zones can be achieved, however a more complex digital map may be required.

Various embodiments of the above methods may be implemented:

1. The digital maps storage and the fire enable decisions may be performed either at the computer in the control center, or in the controller in the patrol unit. In the former case, a lower cost implementation may be achieved, whereas in the latter case a faster response time may be achieved.

2. In one embodiment, the safety zones are stored in a computer's memory. In another embodiment, the safety zones are computed in real time, as required. In yet another embodiment, the safety zone itself is not stored. Rather, only a decision is made, whether the present firing command will result in firing at a safety zone.

According to the invention, an actual firing command is issued to the weapon 12 only if predefined conditions are met in the computer 42, otherwise the firing command will not be executed. The computer 42 is connected to a map storage means 421, which holds information regarding protected zones. As the target's location is computed in computer 42, the computer further checks whether that target's location is within one of the safe zones. If the answer is positive, then the weapons activation command will not be executed.

Optionally, a warning will be displayed to the operator, indicating that the weapon is not being activated, and the reason therefor.

The operator can update or change the map of protected zones, using the map update input channel 442.

FIGS. 10 and 11 detail the method of operation of the electronic safety means for firearms activation. The computer at the center may receive from the patrol unit its location, its gun bearing (azimuth and elevation for example) and, optionally, the distance to target (if a range finder is being used). The computer can then calculate the target's location and compare it with a digitized map in its memory.

The computer will enable shooting only at targets out of the abovedetailed safety zones.

An authorized user will be allowed to add or delete or otherwise edit the information in the digitized map, or change the safety mode—allow shooting only at targets outside safety angles as indicated in FIG. 10, or allow shooting only at targets outside of safety zones, see FIG. 11.

Safety Zones Method

FIG. 10 illustrates an angle safety mode of operation, wherein safety zones are shaped as angular sectors 51. Such sectors may include, for example, protected zones such as areas 511 held by friendly forces, a hospital 512 and/or a village 513.

As the carriage 1 moves along the border 53, the computer 42 at the control center either enables or disables firing, according to firing parameters at any instant in time and the map in storage means 421. In this implementation no range information is required.

FIG. 11 illustrates a distance safety mode of operation, wherein safety zones are shaped as closed area patches 52. Such zones may include, for example, areas 521 held by friendly forces, a hospital 522 and/or a village 523. In this implementation, range information is required.

Additionally, the digital map may include topographic height information, as well as information regarding the height of buildings.

It will be recognized that the foregoing is but one example of an apparatus and method within the scope of the present invention and that various modifications will occur to those skilled in the art upon reading the disclosure set forth hereinbefore.

1. A patrol system comprising a carriage supported by and moving along an elongated guiding means, wherein the carriage includes means for its propulsion along the guiding means responsive to motion control signals at its input, sensor means for acquiring data from outside the carriage and control means for generating the motion control signals for activating the propulsion means.

2. The patrol system according to claim 1, wherein the elongated guiding means comprise a rail installed in an area to be patrolled, and wherein the carriage further includes means for attaching to the rail.

3. The patrol system according to claim 2, wherein the rail is installed at a predefined height above ground.

4. The patrol system according to claim 2, wherein the rail is installed on the ground and wherein the carriage further includes means for elevating the carriage or parts thereof responsive to electrical signals.

5. The patrol system according to claim 1, wherein the elongated guiding means comprise one or more parallel cables installed in an area to be patrolled, and wherein the carriage further includes means for attaching to the cables.

6. The patrol system according to claim 5, using three cables running in parallel and not in the same plane.

7. The patrol system according to claim 1, wherein the propulsion means comprise electric motor means or fuel combustion means.

8. The patrol system according to claim 1, wherein the control means include receiver means for receiving remote control signals from a remote location and means for generating the motion control signals responsive to the received remote control signals.

9. The patrol system according to claim 1, wherein the control means include storage means for storing a motion and surveillance program, and means for generating the motion control signals responsive to the stored program.

10. A control center means for controlling the location and operation of each of a plurality of patrol carriages, comprising means for interfacing with a systems operator, transmitter means for transmitting control signals to the carriages and computer means for generating the control signals responsive to operator's commands, and wherein each carriage includes means for its support by and movement along an elongated guiding means, and wherein the carriage further includes means for its propulsion along the guiding means responsive to motion control signals received from the control center.

11. The control center according to claim 10, wherein the computer means further includes means for controlling each carriage's instrumentation, sensors and weapon means, and motion control means for controlling the carriage's position, velocity and acceleration along the guiding means.

12. The control center according to claim 10, wherein the motion control means further include means for providing fast access by a carriage to any desired location along the guiding means.

13. The control center according to claim 12, wherein the fast access means further include means for planning the carriages movement so as to allow bringing a carriage to any desired location within a predefined maximum time limit.

14. The control center according to claim 10, wherein the carriage motion control is performed responsive to operator's commands or responsive to a program stored and activated in the computer.

15. The control center according to claim 10, wherein the carriage motion control is performed responsive to an alarm signal received at the control center, and further being directed at bringing a carriage to the source of the alarm.

16. The control center according to claim 10, wherein each carriage further includes sensor means and transmitter means for transmitting the sensors output to the control center, and wherein the center further includes means for receiving the sensors output from each carriage.

17. In a patrol system comprising a carriage supported by and moving along an elongated guiding means and a control center, wherein the carriage includes propulsion means, sensor means and remotely activated weapon means, and wherein the control center includes means for remote control of the carriage, an automatic safety method comprising:
A. storing a digital map of safety zones in a computer;
B. keeping track in real time of the carriage location and the area pointed at by the weapon therein;
C. when a weapon activation command is issued, checking whether the intended attack will be pointed towards one of the safety zones;
D. if the answer in step C is negative, then activating the weapon; if the answer is positive, then shooting will not be allowed.

18. The automatic safety method according to claim 17, wherein each of the safety zones is represented as an angular arc.

19. The automatic safety method according to claim 17, wherein each of the safety zones is represented as an area patch, including both angular and range information.

20. The automatic safety method according to claim 17, wherein the digital maps storage and fire enable decisions are performed at the computer in the control center.
